(19) United States
(12) Patent Application Publication
(10) Pub. No.: US 2025/0368180 A1
(43) Pub. Date: Dec. 4, 2025

(54) HYBRID ELECTRIC VEHICLE AND A DRIVING CONTROL METHOD THEREFOR

(71) Applicants: HYUNDAI MOTOR COMPANY, Seoul (KR); KIA CORPORATION, Seoul (KR)

(72) Inventors: Won Bin Lee, Hwaseong-si (KR); Jong Bum Oh, Hwaseong-si (KR)

(73) Assignees: HYUNDAI MOTOR COMPANY, Seoul (KR); KIA CORPORATION, Seoul (KR)

(21) Appl. No.: 18/946,593

(22) Filed: Nov. 13, 2024

(30) Foreign Application Priority Data
May 29, 2024 (KR) 10-2024-0070305

(51) Int. Cl. B60W 20/13; B60K 6/40; B60W 10/06; B60W 10/26

(52) U.S. Cl. CPC B60W 20/13; B60W 10/06; B60W 10/26; B60K 6/40; B60W 2510/244; B60W 2552/15; B60W 2710/0644; B60Y 2200/92

(57) ABSTRACT

A hybrid electric vehicle and a driving control method therefor are provided. The method for controlling a hybrid electric vehicle includes: acquiring a state of charge (SOC) of a battery and determining traveling energy of the vehicle, in response to downhill driving of the vehicle starting; determining, based on the SOC of the battery and the driving energy, whether a condition for entering an engine speed control mode is met; and discharging, when the condition for entering the engine speed control mode is met, the battery by controlling the speed of an engine by using a first motor permanently connected to the engine while the engine is disconnected from wheels.

### CROSS-REFERENCE TO RELATED APPLICATION(S)

This application is based on and claims priority under 35 U.S.C. 119 to Korean Patent Application No. 10-2024-0070305, filed on May 29, 2024, in the Korean Intellectual Property Office, the disclosure of which is herein incorporated by reference in its entirety.

### BACKGROUND OF THE DISCLOSURE

### 1. Technical Field

The present disclosure relates to a hybrid electric vehicle and a driving control method therefor, wherein drivability can be improved in a long-downhill driving situation.

### 2. Description of the Related Art

With the growing concern for the environment in recent times, there has been a rise in the number of eco-friendly vehicles equipped with electric motors as power sources. Eco-friendly vehicles, also known as electrified vehicles, include prominent examples such as hybrid electric vehicles (HEVs) and electric vehicles (EVs).

Among these, hybrid electric vehicles can improve fuel efficiency by switching between an EV mode, where only a motor is driven, and an HEV mode, where the motor is selectively used while an engine is driven, depending on driving conditions.

In hybrid electric vehicles, two electric motors are sometimes used. One motor is used as a drive motor for transmitting power to the wheels, while the other motor is primarily used for starting an engine or generating electricity by using power from the engine. This is often referred to as a hybrid starter generator (HSG). Typically, the HSG is connected to the engine via a pulley and a belt and is used for limited purposes such as engine speed control, in addition to the aforementioned engine starting and power generation functions. Also, typically, the HSG does not transmit a driving force to wheels.

In hybrid electric vehicles, during downhill driving, a battery is charged through power generation, while a motor outputs negative torque. However, when the downhill driving continues, the state of charge (SOC) of the battery maintains a high level, so that the motor may not output negative torque due to battery charging limitations.

During gear shifting in hybrid electric vehicles, motor torque is used for shift speed control through functions such as intervention, active shift control (ASC) speed control, and anti-jerk. If negative torque cannot be output due to charging limitations, proper speed control may not be performed, resulting in the deterioration of drivability.

### SUMMARY OF THE DISCLOSURE

Therefore, in the present technical field, there is a need for a technology that can improve vehicle drivability by predicting situations in which the downhill driving of a hybrid electric vehicle continues.

A technical aspect of the present disclosure is to provide a technology that can improve the drivability of a hybrid electric vehicle by predicting situations in which downhill traveling (i.e., downhill driving) of the hybrid electric vehicle continues.

Another technical aspect of the present disclosure is to provide a technology that can improve the drivability of a hybrid electric vehicle by securing a charge margin through continuous proactive discharging of battery power in response to the state of charge (SOC) of a hybrid electric vehicle battery being expected to reach an overcharged state.

The technical aspects pursued in the present disclosure may not be limited to the above-mentioned technical aspects. Other technical aspects, which are not mentioned herein, should be more clearly understood from the following descriptions by those having ordinary skill in the art to which the present disclosure pertains.

The above aspects may be realized by a method for controlling a hybrid electric vehicle, according to an embodiment of the present disclosure. The method includes: acquiring a state of charge (SOC) of a battery and determining traveling energy (i.e., driving energy) of the hybrid electric vehicle, in response to downhill traveling of the hybrid electric vehicle starting; determining, based on the SOC of the battery and the traveling energy, whether a condition for entering an engine speed control mode is met; and discharging, when the condition for entering the engine speed control mode is met, the battery by controlling a speed of an engine by using a first motor permanently connected to the engine while the engine is disconnected from wheels.

The condition for entering the engine speed control mode may include at least one of: whether the engine is disconnected from the wheels; whether the SOC of the battery is equal to or greater than a first threshold percentage; whether the hybrid electric vehicle has traveled (i.e., has driven) on a downhill slope for a certain period of time or longer; whether the traveling energy of the hybrid electric vehicle has fallen below a predetermined value based on the SOC of the battery at the start of downhill traveling; or a combination thereof.

The method for controlling the hybrid electric vehicle may further include discontinuing the engine speed control mode when a condition for terminating the engine speed control mode is met. The engine speed control mode may use the first motor.

The condition for terminating the engine speed control mode may include at least one of: whether the SOC of the battery is equal to or less than a second threshold percentage; whether a gradient of the ground on which the hybrid electric vehicle is traveling (i.e., driving) is equal to or less than a certain angle; whether a current vehicle speed is equal to or lower than a threshold speed; whether the engine is disconnected from the wheels; or a combination thereof.

The first motor may be selectively connected, via an engine clutch, to a second motor connected to a transmission. An engine shaft of the engine and a motor shaft of the first motor may be directly connected to each other so as to rotate together at all times.

In discharging the battery, the battery may be discharged by controlling, through the first motor, the speed of the engine to converge to a speed of the second motor.

The traveling energy may be determined by integrating a vehicle output amount. The vehicle output amount may be obtained by multiplying a total driving source torque of the hybrid electric vehicle by a vehicle speed.

The total driving source torque may be obtained by summing a torque of the engine, a torque of the first motor, and a torque of the second motor.

The second motor may be a driving motor configured to drive the hybrid electric vehicle.

A hybrid electric vehicle according to an embodiment of the present disclosure includes an engine, a first motor permanently connected to the engine, and a hybrid control unit. The hybrid control unit is configured to: determine, based on a state of charge (SOC) of a battery and traveling energy of the hybrid electric vehicle, whether a condition for entering an engine speed control mode is met in response to downhill traveling of the hybrid electric vehicle starting; and discharge, when the condition for entering the engine speed control mode is met, the battery by controlling a speed of the engine by using the first motor while the engine is disconnected from wheels.

The condition for entering the engine speed control mode may include at least one of: whether the engine is disconnected from the wheels; whether the SOC of the battery is equal to or greater than a first threshold percentage; whether the hybrid electric vehicle has traveled on a downhill slope for a certain period of time or longer; whether the traveling energy of the hybrid electric vehicle has fallen below a predetermined value based on the SOC of the battery at the start of downhill traveling; or a combination thereof.

The hybrid control unit may be configured to discontinue the engine speed control mode when a condition for terminating the engine speed control mode is met. The engine speed control mode may use the first motor.

The condition for terminating the engine speed control mode may include at least one of: whether the SOC of the battery is equal to or less than a second threshold percentage; whether a gradient of the ground on which the hybrid electric vehicle is traveling is equal to or less than a certain angle; whether a current vehicle speed is equal to or lower than a threshold speed; whether the engine is disconnected from the wheels; or a combination thereof.

The first motor may be selectively connected, via an engine clutch, to a second motor connected to a transmission. An engine shaft of the engine and a motor shaft of the first motor may be directly connected to each other so as to rotate together at all times.

The hybrid control unit may be configured to discharge the battery by controlling, through the first motor, the speed of the engine to converge to a speed of the second motor.

The traveling energy may be determined by integrating a vehicle output amount. The vehicle output amount may be obtained by multiplying a total driving source torque of the hybrid electric vehicle by a vehicle speed.

The total driving source torque may be obtained by summing a torque of the engine, a torque of the first motor, and a torque of the second motor.

The second motor may be a driving motor configured to drive the hybrid electric vehicle.

According to various embodiments of the present disclosure as described above, the drivability of the hybrid electric vehicle may be improved by predicting a situation in which downhill traveling of the hybrid electric vehicle continues.

Furthermore, in response to the state of charge (SOC) of the hybrid electric vehicle battery being expected to reach an overcharged state, the drivability of the vehicle is improved by securing s a charge margin through the continuous consumption of battery power.

Furthermore, in long-downhill traveling (i.e., long-downhill driving), continuous discharge may be used to secure a battery charge margin for drivability improvement functions, such as gear-shifting intervention, active shift control (ASC) speed control, and anti-jerk torque.

Advantageous effects obtainable from the present disclosure may not be limited to the above mentioned effects. Other effects which are not mentioned herein may be clearly understood from the following descriptions by those having ordinary skill in the art to which the present disclosure pertains.

### BRIEF DESCRIPTION OF THE DRAWINGS

The above and other aspects, features and advantages of the present disclosure should be more apparent from the following detailed description taken in conjunction with the accompanying drawings.

FIG. 1 illustrates an example of a powertrain configuration of a hybrid electric vehicle according to an embodiment of the present disclosure.

FIG. 2 illustrates an example of a control system configuration of a hybrid electric vehicle according to an embodiment of the present disclosure.

FIG. 3 illustrates an example in which a hybrid electric vehicle according to an embodiment of the present disclosure drives down a long downhill.

FIG. 4 illustrates an example in which drivability deteriorates due to limitation of additional battery charging in the hybrid electric vehicle of FIG. 3.

FIG. 5 illustrates an example in which a drivability deterioration interval is shortened by delaying the start timing of limiting additional charging through battery discharging in the hybrid electric vehicle of FIG. 3.

FIG. 6 is a block diagram illustrating a configuration of a hybrid control unit according to an embodiment of the present disclosure.

FIG. 7 illustrates changes in engine speed, motor speed P2, motor torque P1, and engine friction torque when a hybrid electric vehicle according to an embodiment of the present disclosure enters an engine speed control mode or leaves the engine speed control mode.

FIG. 8 is a flowchart illustrating a driving control method of a hybrid control unit according to an embodiment of the present disclosure.

### DETAILED DESCRIPTION

Hereinafter, embodiments herein are described in detail with reference to the accompanying drawings. The same or similar elements are given the same and similar reference numerals regardless of figure numbers, so duplicate descriptions thereof have been omitted. The terms “module” and “unit” used for the elements in the following description are given or interchangeably used in consideration of only the ease of writing the specification, and do not have distinct meanings or roles by themselves. Furthermore, in describing embodiments set forth herein, a detailed description of known relevant technologies has been omitted when it is determined that the description may make the subject matter of the present disclosure obscure. In addition, it should be appreciated that the accompanying drawings are provided only for the sake of easy understanding of embodiments set forth herein. The technical idea of the present disclosure is not limited to the accompanying drawings and includes all modifications, equivalents, or alternatives falling within the spirit and scope of the present disclosure.

Terms including an ordinal number such as “a first”, “a second”, and the like may be used to describe various elements, but the elements are not limited to the terms. The above terms are used merely for the purpose of distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression includes a plural expression unless they are definitely different in the context.

As used herein, the terms “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof. Further, terms like “travel,” “traveling,” or “traveled” may be used to describe or indicate “drive,” “driving,” “drove,” or “driven” such that the terms like “travel,” “traveling,” or “traveled” may be changed to “drive,” “driving,” “drove,” or “driven.” In addition, these terms may be interchangeable based on the context of the description.

A unit or a control unit included in names such as a motor control unit (MCU) and a hybrid control unit (HCU) is merely a term widely used for naming a controller configured to control a specific function of a vehicle but does not mean a generic function unit. For example, in order to control a function that a control unit is responsible for, each control unit may include a communication device configured to communicate with a sensor or another control unit, a memory configured to store an operation system, a logic command, or input/output information, and at least one processor configured to perform determination, calculation, decision or the like which are required for responsible function controlling. When a component, unit, module, controller, device, element, apparatus, or the like of the present disclosure is described as having a purpose or performing an operation, function, or the like, the component, unit, module, controller, device, element, apparatus, or the like should be considered herein as being “configured to” meet that purpose or to perform that operation or function. Each component, unit, module, controller, device, element, apparatus, and the like may separately embody or be included with a processor and a memory, such as a non-transitory computer readable media, as part of the apparatus.

In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Before describing a method for controlling a hybrid electric vehicle (HEV) according to embodiments of the present disclosure, the structure and control system of a hybrid electric vehicle applicable to embodiments are first described.

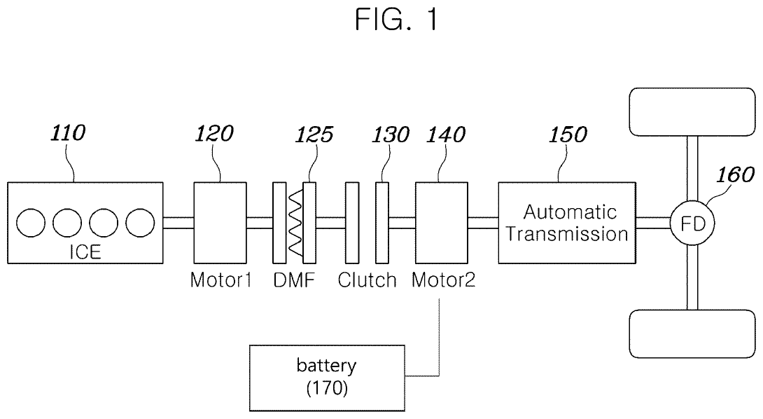

FIG. 1 illustrates an example of the powertrain configuration of a hybrid electric vehicle according to an embodiment of the present disclosure.

FIG. 1 illustrates the powertrain of a hybrid electric vehicle employing a parallel-type hybrid system having two motors 120 and 140 and an engine clutch 130 mounted between an engine (internal combustion engine (ICE)) 110 and a transmission 150. The parallel-type hybrid system is sometimes referred to as a transmission mounted electric drive (TMED) hybrid system because the motor 140 is always connected to an input end of the transmission 150.

A first motor 120 of the two motors 120 and 140 may be disposed between the engine 110 and the engine clutch 130.

An engine shaft of the engine 110 and a first motor shaft of the first motor 120 are directly connected to each other and thus may rotate together at all times.

The first motor 120 may be directly connected to the engine, such as in the structure of FIG. 1. However, the present disclosure is not limited thereto, and it is sufficient for the first motor 120 to be always connected. For example, the engine 110 and the first motor 120 may have a pulley-belt connection structure.

One end of a second motor shaft of a second motor 140 is connected to the other end of the engine clutch 130. The other end of the second motor shaft may be directly connected to an input end of the transmission 150.

The second motor 140 may have a higher output than the first motor 120. The second motor 140 may function as a driving motor. Furthermore, the first motor 120 may function as a starter motor configured to crank the engine 110 when starting the engine 110. The first motor 120 may recover the rotational energy of the engine 110 through power generation when the engine is off. The first motor 120 may also perform power generation with the power of the engine 110 while the engine 110 is running.

In a hybrid electric vehicle having the powertrain as shown in FIG. 1, when a driver presses an accelerator pedal after starting (e.g., HEV Ready), the second motor 140 is first driven using power from a battery 170 while the engine clutch 130 remains open. Power from the second motor 140 is then sent through the transmission 150 and a final drive (FD) 160 to move the wheels (i.e., electric vehicle or EV mode). As the vehicle gradually accelerates and requires more and more driving force, the first motor 120 may operate to crank the engine 110.

After the engine 110 is started, only when the difference between the rotational speeds of the engine 110 and the second motor 140 is within a certain range, the engine clutch 130 is engaged, causing the engine 110 and the second motor 140 to rotate together (i.e., transition from the EV mode to an HEV mode). As a result, through a torque blending process, the output of the second motor 140 decreases while the output of the engine 110 increases, thereby satisfying the driver's required torque. In the HEV mode, a majority of the required torque may be satisfied by the engine 110, and the difference between the engine torque and the required torque may be compensated by at least one of the first motor 120 and the second motor 140. For example, when the engine 110 outputs a torque that is higher than the required torque in consideration of the efficiency of the engine 110, the first motor 120 or the second motor 140 may generate power equivalent to the excess engine torque. When the engine torque is lower than the required torque, at least one of the first motor 120 and the second motor 140 may output the deficient torque.

When a preset engine-off condition such as the vehicle deceleration is met, the engine clutch 130 is opened and the engine 110 is stopped (i.e., transitioning from the HEV mode to the EV mode). During deceleration, the second motor 140 charges the battery 170 by using the driving force of the wheels. This is referred to as braking energy regeneration or regenerative braking.

In general, a stepped transmission, or a multi-plate clutch transmission such as a dual-clutch transmission (DCT) may be used as the transmission 150.

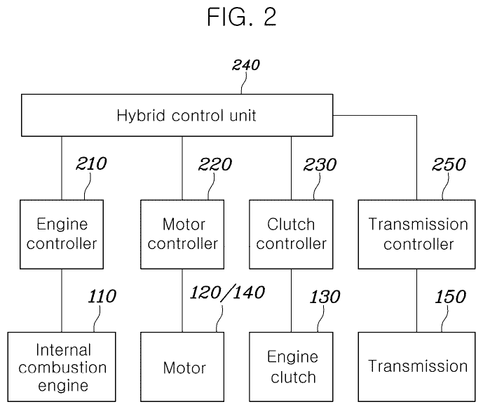

FIG. 2 illustrates an example of a control system configuration of a hybrid electric vehicle according to an embodiment of the present disclosure.

Referring to FIG. 2, in a hybrid electric vehicle to which embodiments of the present disclosure may be applied, the internal combustion engine 110 may be controlled by an engine controller 210, the torque of the first motor 120 and the second motor 140 may be controlled by a motor controller (MCU) 220, and the engine clutch 130 may be controlled by a clutch controller 230. The engine controller 210 may also be referred to herein as an engine management system (EMS). Furthermore, the transmission 150 may be controlled by a transmission controller 250.

The motor controller 220 may control a gate drive unit (not shown) with a control signal in the form of pulse width modulation (PWM), based on the motor angle, phase voltage, phase current, required torque, and the like of each of the motors 120 and 140. The gate drive unit may control an inverter (not shown) that drives each of the motors 120 and 140 accordingly.

Each controller may be connected to a hybrid control unit (HCU) 240, which is a higher-level controller and controls the entire powertrain, including a mode switching process. Each controller under the control of the hybrid control unit 240, may provide, to the hybrid control unit 240, information necessary for controlling the engine clutch at the time of gear shifting or driving mode switching and/or information necessary for controlling engine stop, or perform an operation in response to control signals.

For example, the hybrid control unit 240 determines whether to perform a transition between EV-HEV modes or between charge-depleting and charge-sustaining modes (CD-CS modes) for plug-in hybrid electric vehicles (PHEVs) based on the vehicle's traveling state. To this end, the hybrid control unit determines when to open the engine clutch 130 and performs hydraulic control at the time of opening. Furthermore, the hybrid control unit 240 may determine the state (lock-up, slip, open, and the like.) of the engine clutch 130. The hybrid control unit 240 may control when to stop fuel injection of the engine 110. Furthermore, in order to control engine stop, the hybrid control unit may transmit a torque command to the motor controller 220 to control the torque of the first motor 120, thereby controlling engine rotation energy recovery. Furthermore, the hybrid control unit 240 may determine the states of each of the driving sources 110, 120, and 140 to satisfy the required torque. The hybrid control unit 240 may determine a required driving force to be allocated to each of the driving sources 110, 120, and 140 accordingly. The hybrid control unit 240 may transmit torque commands to the controllers 210 and 220 controlling the driving sources.

It should be apparent to those having ordinary skill in the art that the connection relationship between the controllers and functions/distinctions of each controller, described above, are example and not limited by the names thereof. For example, the hybrid control unit 240 may be implemented such that the functions thereof are alternatively provided by any one of the other controllers, or the functions of the hybrid control unit 240 may be distributed and provided among two or more of the other controllers.

It should be apparent to those having ordinary skill in the art that the above-described configurations in shown in FIGS. 1 and 2 are merely examples of hybrid electric vehicle configurations. Therefore, hybrid electric vehicles applicable to embodiments are not limited to these configurations.

Hereinafter, a hybrid system and a traveling control method thereof are proposed, wherein in a situation where battery overcharging is expected due to long-downhill traveling, battery power is continuously consumed through engine speed control using a motor to secure a charge margin, thereby improving drivability.

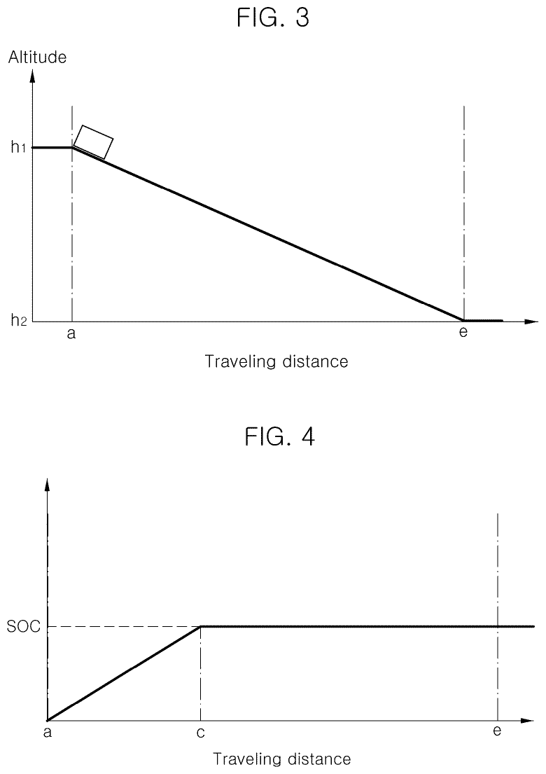

First, referring to FIGS. 3-5, a description is made of an example in which deterioration of drivability is delayed due to charging limitation in a hybrid electric vehicle in a situation where the vehicle travels down a long downhill.

FIG. 3 illustrates an example in which a hybrid electric vehicle according to an embodiment of the present disclosure travels down a long downhill. FIG. 4 illustrates an example in which drivability deteriorates due to limitation of additional battery charging in the hybrid electric vehicle of FIG. 3.

Referring to FIGS. 3 and 4, the hybrid electric vehicle may charge a battery by using regenerative braking force while traveling down a long-downhill from point a at an altitude of h1 to point e at an altitude of h2, which is lower than h1. At a certain point, point c, the battery may be fully charged or reach an SOC set as the upper limit of charging, thereby limiting charging. In this case, from point c to point e, the vehicle's drivability deteriorates as the motor is unable to output negative torque due to the battery charging limitation.

The negative torque refers to a situation where the direction of torque (rotation force) coming from the motor acts in the opposite direction to torque coming from the internal combustion engine. In other words, the negative torque refers to a situation where the motor is not supporting the internal combustion engine, but rather providing resistance.

In hybrid electric vehicles, when the motor cannot output negative torque due to the battery charging limitation, the vehicle's drivability may deteriorate, thereby affecting acceleration, deceleration, traveling safety, and the like. Therefore, it is necessary to consider the design and driving method of a hybrid electric vehicle to minimize situations where the battery charging is limited due to long-downhill traveling, thereby improving drivability.

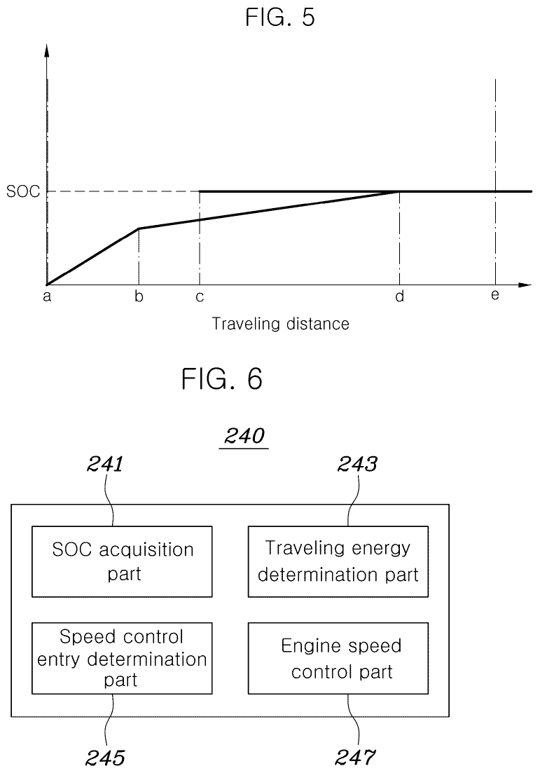

FIG. 5 illustrates an example in which a drivability deterioration interval is shortened by delaying the start timing of limiting additional charging through battery discharging in the hybrid electric vehicle of FIG. 3.

Referring to FIG. 5, the vehicle may charge the battery by using regenerative braking during a long-downhill traveling from point a at an altitude of h1 to point e at an altitude of h2, which is lower than h1. The vehicle then discharges the battery from point b before reaching point c, thereby slowing down the speed at which the battery is charged by using the regenerative braking. In this case, at point d after point c, the battery of the vehicle may be fully charged or reach an SOC set as the upper limit of charging, thereby limiting charging. Thus, the vehicle may shorten the interval, in which the drivability deteriorates, to an interval from point d to point e.

FIG. 6 is a block diagram illustrating the configuration of the hybrid control unit 240 according to an embodiment of the present disclosure.

Referring to FIG. 6, the hybrid control unit 240 includes an SOC acquisition part 241, a traveling energy determination part 243, a speed control entry determination part 245, and an engine speed control part 247.

When the vehicle starts downhill traveling, the SOC acquisition part 241 acquires the state of charge (SOC) of a battery (not shown) at the start of downhill traveling.

The SOC acquisition part 241 may acquire the SOC of the battery by measuring the SOC of the battery using an embedded battery sensor or by receiving the SOC value of the battery from an external device or the like.

The traveling energy determination part 243 determines traveling energy of the vehicle and transmits the determined traveling energy to the speed control entry determination part 245.

The traveling energy of the vehicle may be determined by integrating a vehicle output amount, which is calculated by multiplying a total driving source torque of the vehicle (i.e., a torque obtained by summing torques of the engine 110, the first motor 120, and the second motor 140) by a vehicle speed.

When a condition for entering an engine speed control mode is met, the speed control entry determination part 245 enters the engine speed control mode while the engine is disconnected from wheels.

The condition for entering the engine speed control mode may include at least one of: whether the engine 110 is disconnected from the wheels; whether the state of charge (SOC) of the battery is equal to or greater than a first threshold percentage; whether the vehicle has traveled on a downhill slope for a certain period of time or longer; whether the traveling energy of the vehicle has fallen below a predetermined value based on the SOC of the battery at the start of downhill traveling; or a combination thereof.

The disconnection of the engine 110 from the wheels implies that the engine clutch 130 is disengaged (open).

Determining whether the engine clutch 130 has been disengaged (open) is done to ensure that controlling the speed of the engine 110 by the first motor 120 does not affect the actual driving of the wheels.

When the engine clutch 130 is not disengaged, the speed control entry determination part 245 may control the engine clutch 130 to be disengaged (open). In this case, the speed control entry determination part 245 may identify that the engine clutch 130 is disengaged and may enter the engine speed control mode.

Furthermore, determining whether the state of charge (SOC) of the battery (not shown) is equal to or greater than the first threshold percentage is made because battery charging can be limited only when the SOC of the battery is at or above a certain level

Furthermore, determining whether the vehicle has traveled on the downhill slope for a certain period of time or longer is made because, when the length of the downhill slope is short, battery charging by regenerative braking may be stopped before the e battery (not shown) becomes overcharged.

Furthermore, preset traveling energy based on the SOC of the battery at the start of downhill traveling of the vehicle may be set as multiple differentiated traveling energy levels according to the SOC, and for example, may be set as shown in Table 1 below.

TABLE 1

| | | | | | | |
|---|---|---|---|---|---|---|
| SOC value (%) | 40 | 50 | 60 | 70 | 80 | 90 |
| traveling | −100 | −70 | −50 | −10 | −5 | −3 |
| energy | | | | | | |

Referring to Table 1, for example, if the SOC of the battery at the start of downhill traveling of the vehicle is 40%, the speed control entry determination part 245 may enter the engine speed control mode when the traveling energy determined by traveling energy determination part 243 is below −100.

Furthermore, if the SOC of the battery at the start of downhill traveling of the vehicle is 608, the speed control entry determination part 245 may enter the engine speed control mode when the traveling energy determined by the traveling energy determination part 243 is below −50.

The speed control entry determination part 245 terminates the engine speed control mode when a condition for terminating the engine speed control mode is met.

The condition for terminating the engine speed control mode may include at least one of: whether the SOC of the battery is equal to or less than a second threshold percentage; whether the gradient of the ground on which the vehicle is traveling is equal to or less than a certain angle; whether a current vehicle speed is equal to or lower than a threshold speed; whether the state of the engine clutch 130 has been changed; or a combination thereof.

The engine speed control part 247 controls the speed of the engine 110 by using the first motor 120 in an engine speed control mode.

In this case, the engine 110 is not driven by fuel, but operates solely due to a load caused by engine friction torque. In this case, the engine speed control part 247 controls, via the first motor 120, the speed of the engine 110 to converge to a target speed.

The target speed may be set to the speed of the second motor 140 but may be set in consideration of battery discharge power and noise, vibration, and harshness (NVH).

The hybrid control unit 240 may set the speed control target speed of the engine 110 to the speed of the second motor 140. When the engine clutch 130 is requested to engage, the hybrid control unit 240 may reduce the engagement time of the engine clutch 130 because of the pre-synchronized speed between the engine 110 and the second motor 140.

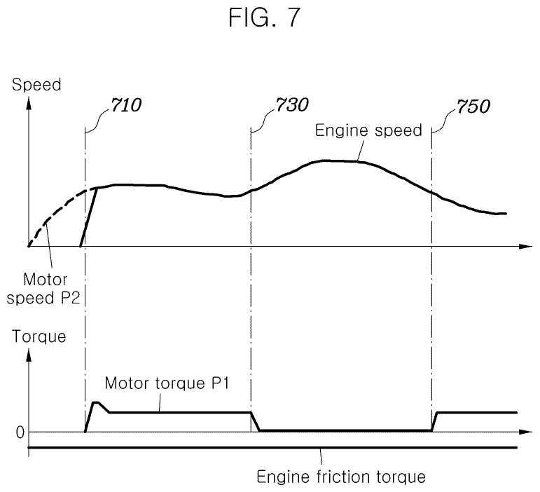

For example, referring to FIG. 7, when the hybrid electric vehicle enters the engine speed control mode at a time point 710, the hybrid electric vehicle synchronizes the speed of the engine 110 with the speed of the second motor 140 by using the output of the first motor 120 in order to discharge the battery while the engine clutch 130 is disengaged (open).

Furthermore, when the engine clutch 130 is requested to engage at the time point 730, the hybrid electric vehicle releases the engine speed control mode and stops controlling the speed of the engine 110 by using the output of the first motor 120. In this case, the battery may discharge power equivalent to the product of the engine friction torque and the engine speed from a time point 710 to the time point 730, i.e., during the duration of the engine speed control mode.

The hybrid electric vehicle may then enter long-downhill traveling at another time point 750 and re-enter the engine speed control mode, wherein the engine clutch 130 may be disengaged and the speed of the engine 110 may be controlled using the output of the first motor 120.

Referring again to FIG. 6, when the engine speed control mode is terminated, the engine speed control part 247 stops controlling the speed of the engine 110 by using the first motor 120.

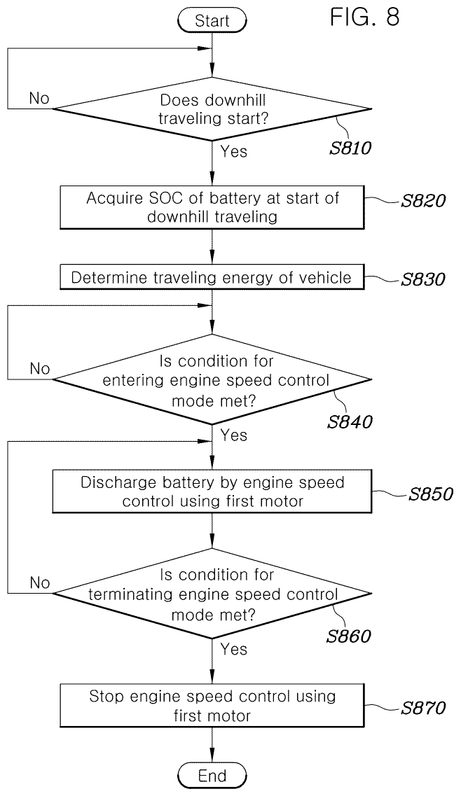

FIG. 8 is a flowchart illustrating a traveling control method of a hybrid control unit according to an embodiment of the present disclosure.

Referring to FIG. 8, the hybrid control unit 240 determines whether the vehicle has started downhill traveling (S810). When the vehicle has begun downhill traveling, the hybrid control unit 240 acquires the state of charge (SOC) of the battery (not shown) at the start of the downhill traveling (S820).

The hybrid control unit 240 may obtain the SOC of the battery by measuring the SOC of the battery via an embedded battery sensor or by receiving an SOC value of the battery from an external device or the like.

Furthermore, the hybrid control unit 240 determines traveling energy of the vehicle (S830).

The traveling energy of the vehicle may be determined by integrating a vehicle output amount, which is obtained by multiplying the total torque of the vehicle (i.e., a torque obtained by summing torques of the engine 110, the first motor 120, and the second motor 140) by the speed of the vehicle.

The hybrid control unit 240 determines, based on the SOC of the battery and the traveling energy of the vehicle, whether a condition for entering an engine speed control mode is met (S840). When the condition for entering the engine speed control mode is met, the hybrid control unit 240 discharges the battery by controlling the speed of the engine by using the first motor 120 while the engine is disconnected from the wheels (S850).

In operation S840, the condition for entering the engine speed control mode may include at least one of: whether the engine 110 is disconnected from the wheels; whether the state of charge (SOC) of the battery is equal to or greater than a first threshold percentage; whether the vehicle has traveled on a downhill slope for a certain period of time or longer; whether the traveling energy of the vehicle has fallen below a predetermined value, based on the SOC of the battery at the start of downhill traveling; or a combination thereof.

The disconnection of the engine 110 from the wheel implies that the engine clutch 130 is disengaged (open).

Determining whether the engine clutch 130 has been disengaged (open) is done to ensure that controlling the speed of the engine 110 by the first motor 120 does not affect the actual driving of the wheels.

When the engine clutch 130 is not disengaged, the speed control entry determination part 245 may control the engine clutch 130 to be disengaged (open). In this case, the speed control entry determination part 245 may determine that the engine clutch 130 is disengaged and enter the engine speed control mode.

In this case, the engine 110 is not driven by fuel, but operates solely due to a load caused by engine friction torque. In this case, the hybrid control unit 240 controls, via the first motor 120, the speed of the engine 110 to converge to a target speed.

The target speed may be set to the speed of the second motor 140. In this case, the speed of the second motor 140 may be set in consideration of battery discharge power and noise, vibration, and harshness (NVH).

The hybrid control unit 240 may set the speed control target speed of the engine 110 to the speed of the second motor 140. When the engine clutch 130 is requested to engage, the hybrid control unit 240 may reduce the engagement time of the engine clutch 130 because of the pre-synchronized speed between the engine 110 and the second motor 140.

The hybrid control unit 240 determines whether a condition for terminating the engine speed control mode is met (S860). When the condition for terminating the engine speed control mode is met, the hybrid control unit 240 stops the engine speed control using the first motor 120 (S870).

The condition for terminating the engine speed control mode may include at least one of: whether the SOC of the battery is equal to or less than a second threshold percentage; whether the gradient of the ground on which the vehicle is traveling is equal to or less than a certain angle; whether a current vehicle speed is equal to or lower than a threshold speed; whether the state of the engine clutch 130 has been changed; or a combination thereof.

The second threshold percentage may be set to various values and may be the same as or different from the first threshold percentage used for the condition for entering the engine speed control mode.

The reason for determining whether the SOC of the battery is equal to or less than the second threshold percentage is that when the battery finishes traveling down on a slope and travels on a regular road, battery charging by regenerative braking may ends, and thus the battery may be consumed.

According to the above-described embodiments of the present disclosure, the drivability of the vehicle is improved by predicting the situation in which downhill traveling of the hybrid electric vehicle continues.

Furthermore, when the state of charge (SOC) of the hybrid electric vehicle battery is expected to reach an overcharged state, the drivability of the vehicle is improved by securing a charge margin through the continuous consumption of battery power.

Furthermore, in long-downhill traveling, continuous discharge may be used to secure a battery charge margin for drivability improvement functions, such as gear-shifting intervention, active shift control (ASC) speed control, and anti-jerk torque.

Embodiments of the present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a read-only memory (ROM), a random access memory (RAM), a compact disc read-only memory (CD-ROM), a magnetic tape, a floppy disk, an optical data storage device, and the like. Therefore, the above detailed description should not be construed in a limitative sense but should be considered in an illustrative sense in all aspects. The scope of the present disclosure should not be determined by reasonable interpretation of the appended claims. All changes and modifications within the equivalent scope of the present disclosure fall within the scope of the present disclosure.

What is claimed is:

1. A method for controlling a hybrid electric vehicle, the method comprising:
acquiring a state of charge (SOC) of a battery in response to downhill driving of the hybrid electric vehicle starting;
determining driving energy of the hybrid electric vehicle;
determining, based on the SOC of the battery and the driving energy, whether a condition for entering an engine speed control mode is met; and
discharging, when the condition for entering the engine speed control mode is met, the battery by controlling a speed of an engine by using a first motor permanently connected to the engine while the engine is disconnected from wheels.

2. The method of claim 1, wherein the condition for entering the engine speed control mode comprises at least one of:
whether the engine is disconnected from the wheels;
whether the SOC of the battery is equal to or greater than a first threshold percentage;
whether the hybrid electric vehicle has driven on a downhill slope for a certain period of time or longer;
whether the driving energy of the hybrid electric vehicle has fallen below a predetermined value based on the SOC of the battery at a start of downhill driving; or
a combination thereof.

3. The method of claim 1, further comprising discontinuing the engine speed control mode when a condition for terminating the engine speed control mode is met, wherein the engine speed control mode uses the first motor.

4. The method of claim 3, wherein the condition for terminating the engine speed control mode comprises at least one of:
whether the SOC of the battery is equal to or less than a second threshold percentage;
whether a gradient of a ground on which the hybrid electric vehicle is driving is equal to or less than a certain angle;
whether a current vehicle speed is equal to or lower than a threshold speed;
whether the engine is disconnected from the wheels; or a combination thereof.

5. The method of claim 1, wherein:
the first motor is selectively connected, via an engine clutch, to a second motor connected to a transmission; and
an engine shaft of the engine and a motor shaft of the first motor are directly connected to each other so as to rotate together at all times.

6. The method of claim 5, wherein in discharging the battery, the battery is discharged by controlling, through the first motor, the speed of the engine to converge to a speed of the second motor.

7. The method of claim 5, wherein:
the driving energy is determined by integrating a vehicle output amount; and
the vehicle output amount is obtained by multiplying a total driving source torque of the hybrid electric vehicle by a vehicle speed.

8. The method of claim 7, wherein the total driving source torque is obtained by summing a torque of the engine, a torque of the first motor, and a torque of the second motor.

9. The method of claim 8, wherein the second motor is a driving motor configured to drive the hybrid electric vehicle.

10. A hybrid electric vehicle comprising:
an engine;
a first motor permanently connected to the engine; and
a hybrid control unit configured to
determine, based on a state of charge (SOC) of a battery and driving energy of the hybrid electric vehicle, whether a condition for entering an engine speed control mode is met in response to downhill driving of the hybrid electric vehicle starting, and
discharge, when the condition for entering the engine speed control mode is met, the battery by controlling a speed of the engine by using the first motor while the engine is disconnected from wheels.

11. The hybrid electric vehicle of claim 10, wherein the condition for entering the engine speed control mode comprises at least one of:
whether the engine is disconnected from the wheels;
whether the SOC of the battery is equal to or greater than a first threshold percentage;
whether the hybrid electric vehicle has driven on a downhill slope for a certain period of time or longer;
whether the driving energy of the hybrid electric vehicle has fallen below a predetermined value based on the SOC of the battery at a start of downhill driving; or
a combination thereof.

12. The hybrid electric vehicle of claim 10, wherein the hybrid control unit is configured to discontinue the engine speed control mode when a condition for terminating the engine speed control mode is met, wherein the engine speed control mode uses the first motor.

13. The hybrid electric vehicle of claim 12, wherein the condition for terminating the engine speed control mode comprises at least one of:
whether the SOC of the battery is equal to or less than a second threshold percentage;
whether a gradient of a ground on which the hybrid electric vehicle is driving is equal to or less than a certain angle;
whether a current vehicle speed is equal to or lower than a threshold speed;
whether the engine is disconnected from the wheels; or a combination thereof.

14. The hybrid electric vehicle of claim 10, wherein:
the first motor is selectively connected, via an engine clutch, to a second motor connected to a transmission; and
an engine shaft of the engine and a motor shaft of the first motor are directly connected to each other so as to rotate together at all times.

15. The hybrid electric vehicle of claim 14, wherein the hybrid control unit is configured to discharge the battery by controlling, through the first motor, the speed of the engine to converge to a speed of the second motor.

16. The hybrid electric vehicle of claim 14, wherein:
the driving energy is determined by integrating a vehicle output amount; and
the vehicle output amount is obtained by multiplying a total driving source torque of the hybrid electric vehicle by a vehicle speed.

17. The hybrid electric vehicle of claim 16, wherein the total driving source torque is obtained by summing a torque of the engine, a torque of the first motor, and a torque of the second motor.

18. The hybrid electric vehicle of claim 17, wherein the second motor is a driving motor configured to drive the hybrid electric vehicle.
